(19) United States
(12) Patent Application Publication
(10) Pub. No.: US 2008/0092497 A1
(43) Pub. Date: Apr. 24, 2008

(54) Horse-Used Protective Mask

(76) Inventor: Chia-Wei Chang, Taichung (TW)

Correspondence Address: Alan Kamrath;Kamrath & Associates, P.A., Suite 245, 4825 Olson Memorial Highway, Golden Valley, MN, 55422, US

(21) Appl. No.: 11/869,971

(22) Filed: Oct. 10, 2007

(30) Foreign Application Priority Data
Oct. 20, 2006 (TW) 095218560
Mar. 30, 2007 (TW) 096205267

(51) Int. Cl. B68C 5/00

(52) U.S. Cl. 54/80.2; 54/80.3; 54/80.5

(57) ABSTRACT

A horse-used protective mask including at least one mask composed of symmetrical thermoplastic meshworks and having a configuration adapted to a horse's face for shielding the horse's face. A first connecting section is disposed on a corner of the lower portion of the mask. A second connecting section is disposed on another corner of the lower portion of the mask. The first connecting section can be wound around the chin of a horse to connect with the second connecting section. At least one outward swelling section is formed on the mask near the eyes of the horse. When the mask is fixed on the face of the horse, the inner face of the mask will not touch or abrade the eyes of the horse. In addition, the swelling section is held by small crimped sections away from the eyes of the horse so that the eyesight of the horse will not be obstructed.

### BACKGROUND OF THE INVENTION

The present invention is related to an improved horse-used protective mask which prevents mosquitoes and bugs from touching the eyes and nose of a horse. The protective mask has a configuration adapted to the profile of the face of a horse, whereby the protective mask can be snugly worn on the face of the horse to shield the face.

A conventional horse-used protective mask serves to protect a horse's face from being sunned or stung by insects such as mosquitoes and flies. In addition, in an environment full of trees, leaves or long grasses, the horse-used protective mask serves to prevent the face of the horse from being touched by such alien articles and avoid affection of such alien articles on eyesight of the horse. Furthermore, in a sandy environment, the horse-used protective mask is able to protect the horse's face from being stimulated by the sands so that the horse will not feel uncomfortable to abnormally act or even fall down and get hurt.

Taiwanese Utility Model Patent No. 85217851 discloses a horse-used protective mask. The horse-used protective mask is composed of two meshworks substantially in form of right triangle. Two adjacent edges of the meshworks are sewn with each other to assemble the two meshworks into a mask for shielding the face of a horse. Fastening belts are disposed on two corners of the mask. Two perforations are formed on a top portion of the mask. Two triangularly solid crimped sections with a certain length are formed on the mask respectively under the perforations. The solid crimped sections outward protrude from the mask corresponding to the position of the eyes of the horse. Accordingly, when wearing the mask, the meshworks will not abrade the eyes of the horse.

In the above structure, the portions of the meshworks in front of the eyes of the horse are stitched to form the triangular solid crimped sections. The meshworks are locally multifold crimped and stitched to form the crimped sections. Therefore, the crimped section has a thickness at least twice the thickness of other portions of the mask. As a result, the crimped section forms a relatively rigid projection. When a horse wears the mask and acts, the eyesight of the horse is apt to be obstructed by the rigid crimped sections. Moreover, in the case that an alien article collides the rigid projecting section to squeeze the same, the solid outward protruding sections may become inward recessed. Under such circumstance, the rigid sections may directly touch the eyes of the horse to injure the horse's eyes.

### SUMMARY OF THE INVENTION

It is therefore a primary object of the present invention to provide an improved horse-used protective mask which will not stimulate or injure the eyes of a horse.

According to the above object, the horse-used protective mask of the present invention includes at least one mask composed of symmetrical thermoplastic meshworks. The mask has a configuration of a narrower upper portion and a wider lower portion, which is adapted to a horse's face for shielding the horse's face. Two perforations are symmetrically formed on a top portion of the mask, whereby the ears of the horse can extend out of the mask through the perforations. A first connecting-section is disposed on a corner of the lower portion of the mask. A second connecting section is disposed on another corner of the lower portion of the mask. The first connecting section can be wound around the chin of a horse to connect with the second connecting section. At least one outward swelling section is formed on the mask near the eyes of the horse. When the mask is fixed on the face of the horse, the inner face of the swelling section of the mask will not touch or abrade the eyes of the horse so that the horse will not feel uncomfortable. In addition, the swelling section is held by small crimped sections away from the eyes of the horse so that the eyesight of the horse will not be obstructed.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a sectional view showing the swelling section of the embodiment of FIG. 1;

FIG. 3 is a sectional view showing the swelling section of a second embodiment of the present invention;

FIG. 4 is a sectional view showing the swelling section of a third embodiment of the present invention;

FIG. 5 is a perspective exploded view of a fourth embodiment of the present invention, showing the swelling section thereof;

FIG. 6 is a perspective assembled view of the fourth embodiment of the present invention according to FIG. 5;

FIG. 7 is a sectional view showing the swelling section of the embodiment of FIG. 6;

FIG. 8 is a sectional view showing the swelling section of another embodiment of the present invention;

FIG. 9 shows that a horse wears the mask of the present invention;

FIG. 10 shows that a horse wears the mask of the present invention with the respirator of FIG. 2; and

FIG. 11 shows that a horse wears the mask of the present invention with the respirator of FIG. 5.

### DETAILED DESCRIPTION OF TE PREFERRED EMBODIMENTS

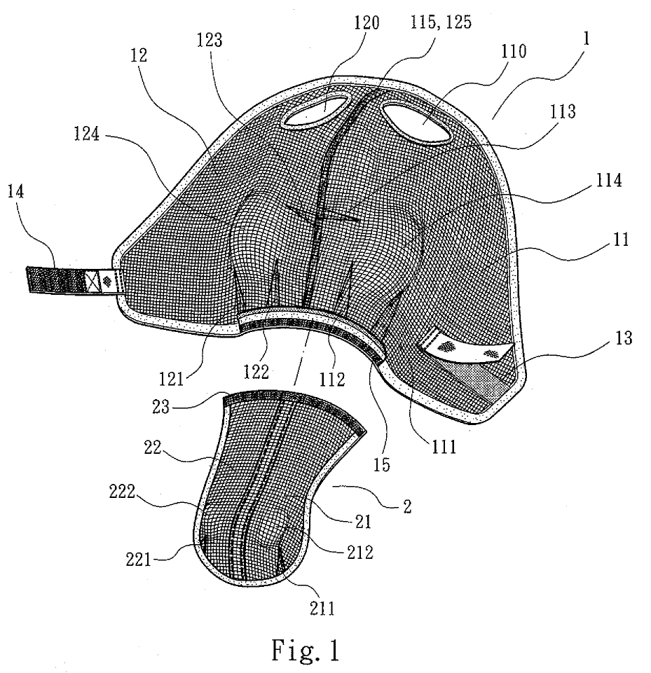

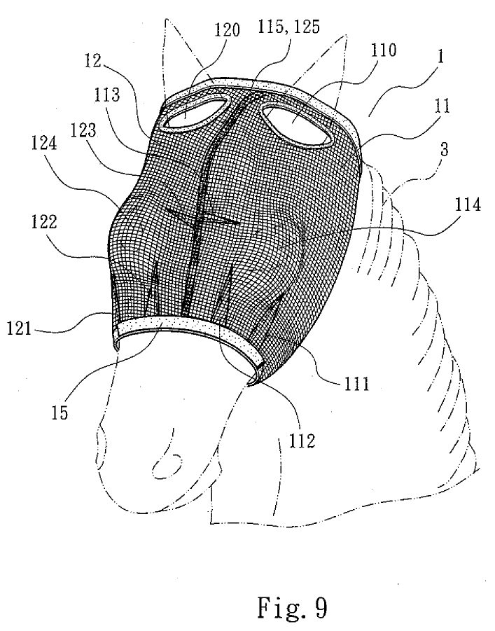

Please refer to FIG. 1. The horse-used protective mask of the present invention is composed of two thermoplastic meshworks 11, 12 substantially in form of right triangle. The meshworks 11, 12 have two edges 115, 125 adjacent to each other. The adjacent edges 115, 125 are sewn with each other to assemble the two meshworks 11, 12 into a mask 1 for shielding the face of a horse 3 as shown in FIG. 9. The mask 1 has a narrower upper portion and a wider lower portion. Two perforations 110, 120 are formed on the top section of the mask 1. The two perforations 110, 120 can be symmetrical to each other. Alternatively, one single larger perforation (not shown) can be formed on the mask 1 across the adjacent edges 115, 125 of the two meshworks 11, 12. Accordingly, the ears of the horse can extend through the two symmetrical perforations or the single perforation of the mask 1. A first connecting section 13 is disposed on a corner of the lower portion of the mask 1. A second connecting section 14 is disposed on another corner of the lower portion of the mask 1. The first connecting section 13 can be wound around the chin of the horse 3 to connect with the second connecting section 14. In this embodiment, the first connecting section 13 includes an upper hook fastener and a lower hook fastener. The second connecting section 14 is a belt-shaped loop fastener which can be adhered to the hook fasteners. In practice, other fasteners can be alternatively used to achieve this effect.

At least one outward swelling section 114, 124 is formed on the meshworks 11, 12 near the eyes of the horse 3. The size and shape of the swelling section 114 are determined by the shape of the head of the horse 3 and the range and size of the eyes of the horse 3. The meshworks 11, 12 are formed with first crimped sections 111, 121 and second crimped sections 112, 122 under the eyes of the horse. In addition, third crimped sections 113, 123 are formed between the upper portions of the eyes of the horse. The crimped sections serve to hold the swelling sections 114, 124. The first, second and third crimped sections 111, 121, 112, 122, 113, 123 have small crimped edges away from the eyes of the horse. In addition, the crimped sections are adapted to the profile of the swelling sections 114, 124. Accordingly, the eyes of the horse 3 will not be hindered from clearly seeing. In contrast, in the conventional mask, a solid area is formed by a longer crimp. This tends to block the eyesight of the horse.

Referring to FIG. 1, this embodiment further includes a respirator 2 composed of a left meshwork 21 and a right meshwork 22 sewn with each other. The respirator 2 is formed with two swelling sections 212, 222 corresponding to the nostrils of the horse. Alternatively, one single larger swelling section can be formed on the respirator 2 across the two meshworks 21, 22 to cover both the nostrils. The swelling sections 212, 222 are held by means of two crimps 211, 221. Accordingly, a lower portion of the respirator 2 is formed with a curved face adapted to the tip of the nose of the horse 3. A coupling section 23 is disposed on an upper edge of the respirator 2. Another coupling section 15 is arranged on the middle of a lower edge of the mask 1 corresponding to the coupling section 23. By means of connecting the coupling sections 23, 15, the respirator 2 can be associated with the mask 1 to together form a complete mask structure for fully protecting the face of the horse 3. In this embodiment, soft fabrics are seamed on the edges of the mask 1, the perforations 110, 120 and the respirator 2 to achieve a comfortable feeling for the horse 3.

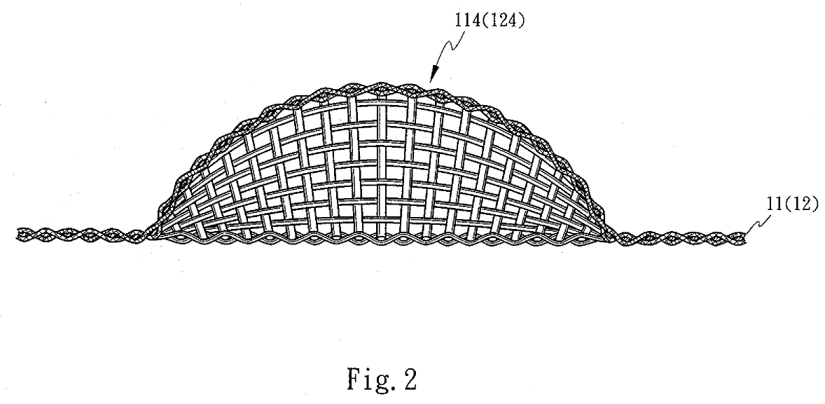

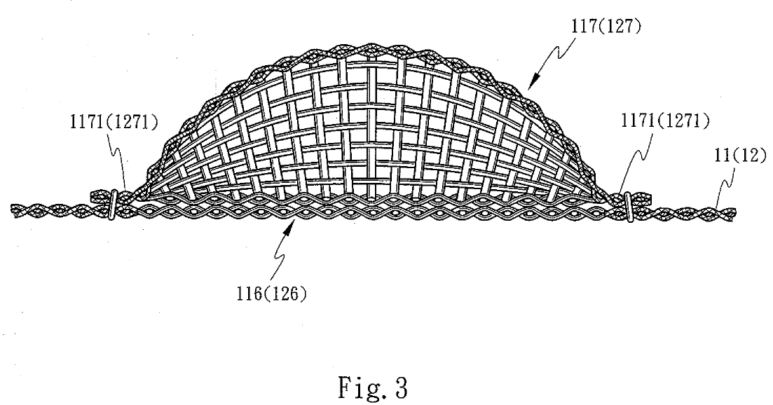

Referring to FIG. 2, in practice, the swelling sections 114, 124 can be formed by means of molding to achieve a bulged state. The swelling sections 114, 124 are directly formed on the meshworks 11, 12 near the eyes of the horse 3. Accordingly, the mask 1 has an integral smooth convex pattern. Referring to FIG. 3, in a preferred embodiment, the portions of the meshworks 11, 12 near the eyes of the horse 3 are removed to form two window sections 116, 126. Two additional cover bodies 117, 127 are connected with the mask 1 to block the window sections 116, 126 to serve as the swelling sections 114, 124. In this embodiment, the cover-bodies 117, 127 are meshworks made of the same material. The meshworks are directly expanded and bulged into a substantially bowl-shaped structure. Each cover body 117, 127 is formed with a flange section 1171, 1271 which is a plane section radially extending from a periphery of the cover body 117, 127. By means of adhesion, fusion, stitching or latching, the flange sections 1171, 1271 are connected with the peripheries of the window sections 116, 126, whereby the bowl-shaped cover bodies 117, 127 can block the window sections 116, 126.

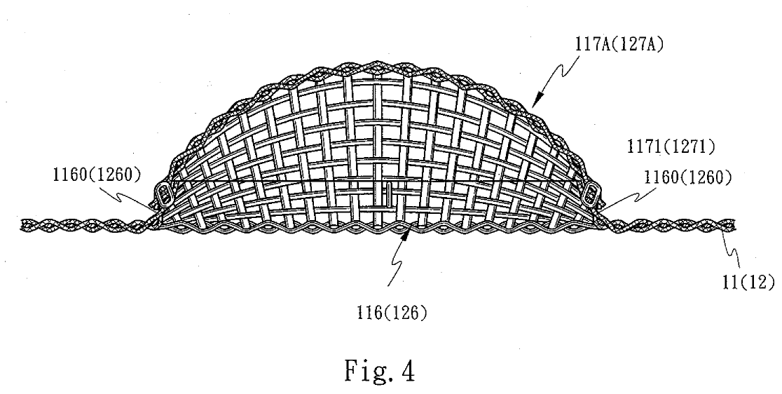

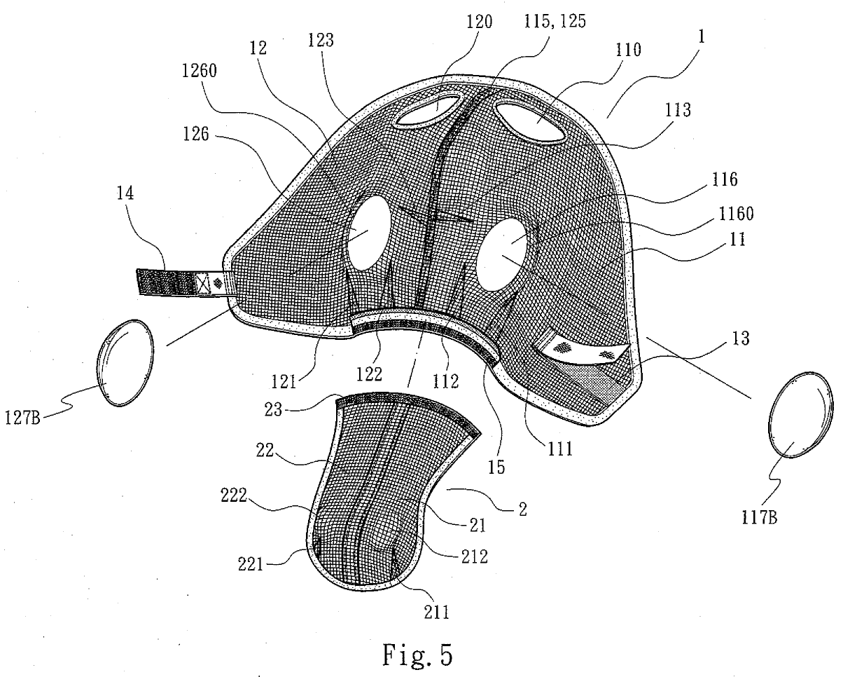

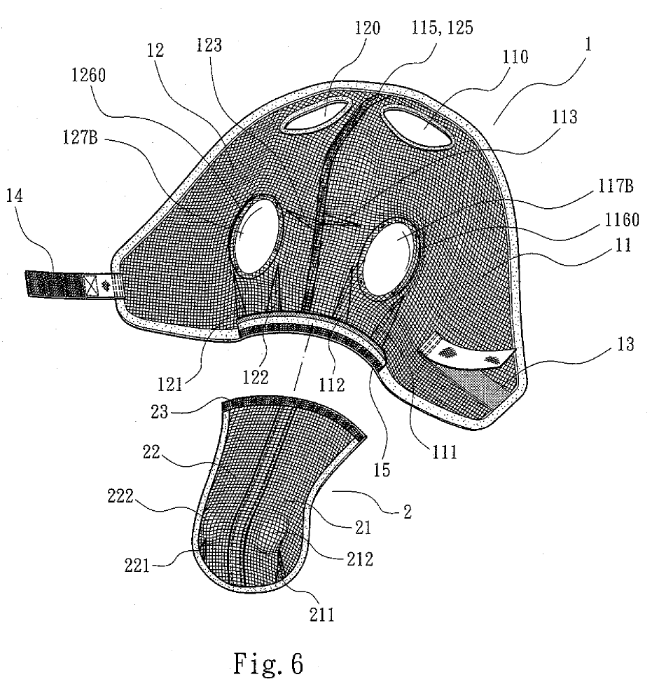

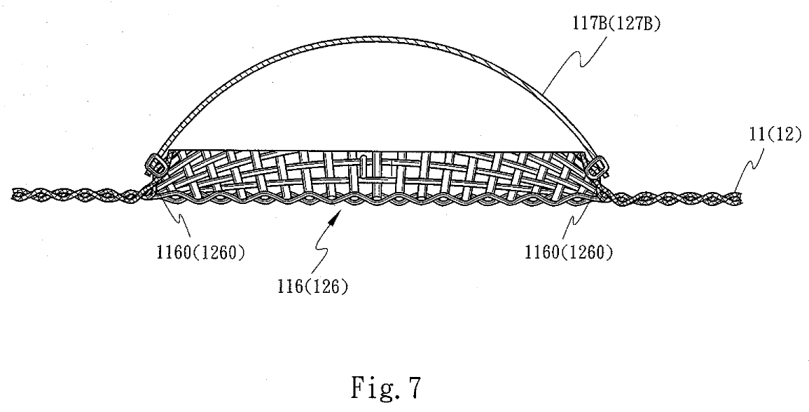

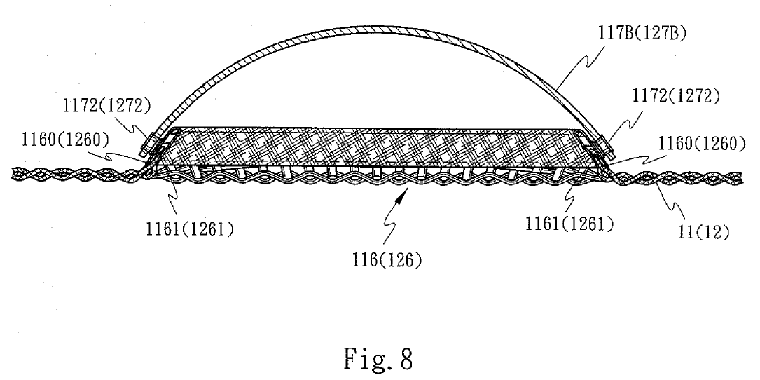

Referring to FIG. 4, in another embodiment, the periphery of each window section 116, 126 has an outward obliquely projecting hub section 1160, 1260. The bowl-shaped cover body 117A, 127A has a configuration adapted to the hub section 1160, 1260. By means of adhesion, fusion, stitching or latching, the bowl-shaped cover bodies 117A, 127A are connected with the hub sections 1160, 1260 of the peripheries of the window sections 116, 126. Accordingly, the bowl-shaped cover bodies 117A, 127A can block the window sections 116, 126. It should be noted that the cover bodies 117A, 127A are meshworks made of the same material. The material is directly expanded and bulged into the bowl-shaped structure. The cover bodies 117A, 127A only have a convex configuration without the flange sections 1171, 1271 as shown in FIG. 3. FIGS. 5 to 8 show that the cover bodies 117B, 127B are alternatively made of transparent materials such as transparent, semitransparent or colored plastics or glass. The cover bodies 117B, 127B can have different profiles as necessary. The profile of the cover bodies 117B, 127B is not limited to circular shape as shown in FIG. 5. In the case that the cover bodies 117B, 127B are made of the above transparent materials, the cover bodies 117B, 127B can achieve better transparency and shielding effect for the eyes of the horse 3. Accordingly, when wearing the mask 1, the horse 3 can have better eyesight under better protection for the eyes. FIG. 8 shows that the periphery of each window section 116, 126 has an outward obliquely projecting hub section 1160, 1260. The hub section 1160, 1260 is encircled by a soft fabric and equipped with latch sections 1161, 1261. The periphery of each cover body 117B, 127B is equipped with corresponding latch members 1172, 1272 for latching with the latch sections 1161, 1261.

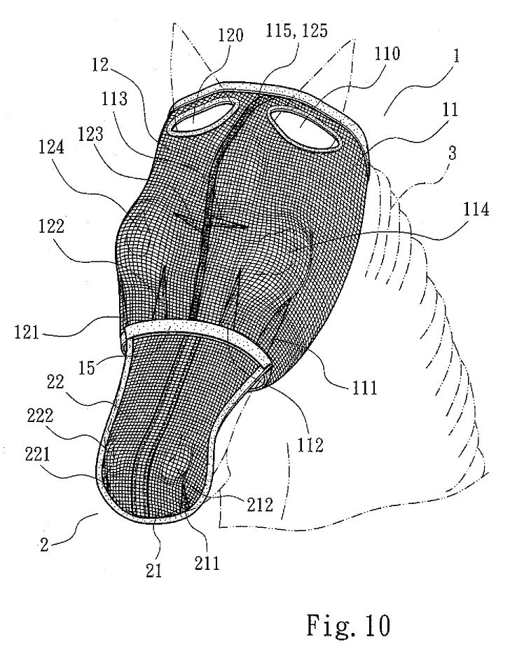

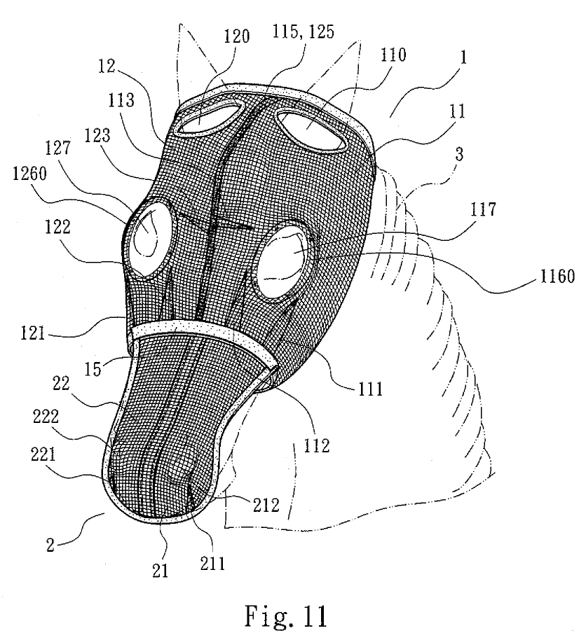

FIGS. 9 to 11 show that the horse 3 wears the mask 1 on its head. When wearing the mask 1, the mask 1 is first stretched as shown in FIG. 1. Then the ears of the horse 3 are fitted through the perforations 110, 120 and the mask 1 is overlaid on left and right sides of the face of the horse 3. The first and second connecting sections 13, 14 disposed on the two corners are connected together under the chin of the horse 3 as shown in FIG. 9. Referring to FIGS. 10 and 11, in another embodiment, the coupling section 23 is connected with the coupling section 15 to associate the respirator 2 with the mask 1. The mask 1 and the respirator 2 together form a mask structure for covering the face and nose of the horse 3. In an outdoor environment with many alien articles which will interfere with the horse 3, the mask structure serves to prevent the horse 3 from being directly sunned and protect the eyes and nose of the horse 3 from being stung by mosquitoes and flies. Therefore, the external interference can be minimized.

In conclusion, the horse-used protective mask of the present invention provides protection for the eyes and nose of a horse. The single-layer smooth convex swelling sections of the mask will not obstruct the eyesight as in the conventional structure. In addition, no hard or rigid part exists in such mask. Therefore, in the case that the mask is squeezed, the eyes, nose and face of the horse will be not injured. Accordingly, the mask of the present invention can provide better protective effect for the horse.

The above embodiments are only used to illustrate the present invention, not intended to limit the scope thereof. Many modifications of the above embodiments can be made without departing from the spirit of the present invention.

What is claimed is:

1. A horse-used protective mask comprising at least one mask composed of symmetrical thermoplastic meshworks, the mask having a configuration of a narrower upper portion and a wider lower portion, which is adapted to a horse's face for shielding the horse's face, a first connecting section being disposed on a corner of the lower portion of the mask, a second connecting section being disposed on another corner of the lower portion of the mask, whereby the first connecting section can be wound around the chin of a horse to connect with the second connecting section, at least one outward swelling section being formed on the meshworks near the eyes of the horse.

2. The horse-used protective mask as claimed in claim 1, wherein the swelling section is directly integrally formed of the same material on the meshworks of the mask near the eyes of the horse.

3. The horse-used protective mask as claimed in claim 1, wherein the portions of the meshworks of the mask near the eyes of the horse are partially removed to form at least one window section, at least one cover body being connected with the mask to block the window section to serve as the swelling section.

4. The horse-used protective mask as claimed in claim 3, wherein the cover body is made of a meshwork material which is directly expanded and bulged into a swelling configuration.

5. The horse-used protective mask as claimed in claim 3, wherein the cover body is made of a transparent material which is directly expanded and bulged into a swelling configuration.

6. The horse-used protective mask as claimed in claim 3, wherein the cover body is formed with a flange section which is a plane section radially extends from a periphery of the cover body, the flange section being connected with a periphery of the window section.

7. The horse-used protective mask as claimed in claim 3, wherein a periphery of the window section has an outward obliquely projecting hub section, the cover body being connected with the hub section of the periphery of the window section to block the window section.

8. The horse-used protective mask as claimed in claim 1, wherein the mask is composed of two meshworks have two adjacent edges, the adjacent edges being sewn with each other to assemble the two meshworks into the mask.

9. The horse-used protective mask as claimed in claim 1, wherein the first connecting section includes an upper hook fastener and a lower hook fastener and the second connecting section is a belt-shaped loop fastener which can be adhered to the hook fasteners.

10. The horse-used protective mask as claimed in claim 1, wherein the mask is formed with first crimped sections and second crimped sections under the eyes of the horse and formed with third crimped sections between upper portions of the eyes of the horse.

11. The horse-used protective mask as claimed in claim 1, wherein a coupling section is arranged on the middle of a lower edge of the mask for connecting with a respirator.

12. The horse-used protective mask as claimed in claim 2, wherein a coupling section is arranged on the middle of a lower edge of the mask for connecting with a respirator.

13. The horse-used protective mask as claimed in claim 3, wherein a coupling section is arranged on the middle of a lower edge of the mask for connecting with a respirator.

14. The horse-used protective mask as claimed in claim 8, wherein a coupling section is arranged on the middle of a lower edge of the mask for connecting with a respirator.

15. The horse-used protective mask as claimed in claim 9, wherein a coupling section is arranged on the middle of a lower edge of the mask for connecting with a respirator.

16. The horse-used protective mask as claimed in claim 10, wherein a coupling section is arranged on the middle of a lower edge of the mask for connecting with a respirator.

17. The horse-used protective mask as claimed in claim 11, wherein the respirator is formed with at least one swelling section corresponding to the nostrils of the horse, a lower portion of the respirator being formed with a curved face adapted to the tip of the nose of the horse, a coupling section being disposed on an upper edge of the respirator, whereby by means of connecting the coupling section of the mask and the coupling section of the respirator, the respirator can be associated with the mask.

18. The horse-used protective mask as claimed in claim 12, wherein the respirator is formed with at least one swelling section corresponding to the nostrils of the horse, a lower portion of the respirator being formed with a curved face adapted to the tip of the nose of the horse, a coupling section being disposed on an upper edge of the respirator, whereby by means of connecting the coupling section of the mask and the coupling section of the respirator, the respirator can be associated with the mask.

19. The horse-used protective mask as claimed in claim 13, wherein the respirator is formed with at least one swelling section corresponding to the nostrils of the horse, a lower portion of the respirator being formed with a curved face adapted to the tip of the nose of the horse, a coupling section being disposed on an upper edge of the respirator, whereby by means of connecting the coupling section of the mask and the coupling section of the respirator, the respirator can be associated with the mask.

20. The horse-used protective mask as claimed in claim 11, wherein the respirator is composed of a left meshwork and a right meshwork sewn with each other.

21. The horse-used protective mask as claimed in claim 12, wherein the respirator is composed of a left meshwork and a right meshwork sewn with each other.

22. The horse-used protective mask as claimed in claim 13, wherein the respirator is composed of a left meshwork and a right meshwork sewn with each other.

23. The horse-used protective mask as claimed in claim 11, wherein the mask and the respirator are associated with each other by means of corresponding adhesive or latching members.

24. The horse-used protective mask as claimed in claim 12, wherein the mask and the respirator are associated with each other by means of corresponding adhesive or latching members.

25. The horse-used protective mask as claimed in claim 13, wherein the mask and the respirator are associated with each other by means of corresponding adhesive or latching members.

26. The horse-used protective mask as claimed in claim 1, wherein at least one perforation is formed on a top portion of the mask, whereby the ears of the horse can extend out of the mask through the perforation.

27. The horse-used protective mask as claimed in claim 2, wherein at least one perforation is formed on a top portion of the mask, whereby the ears of the horse can extend out of the mask through the perforation.

28. The horse-used protective mask as claimed in claim 3, wherein at least one perforation is formed on a top portion of the mask, whereby the ears of the horse can extend out of the mask through the perforation.

29. The horse-used protective mask as claimed in claim 4, wherein at least one perforation is formed on a top portion of the mask, whereby the ears of the horse can extend out of the mask through the perforation.

30. The horse-used protective mask as claimed in claim 5, wherein at least one perforation is formed on a top portion of the mask, whereby the ears of the horse can extend out of the mask through the perforation.

31. The horse-used protective mask as claimed in claim 11, wherein at least one perforation is formed on a top portion of the mask, whereby the ears of the horse can extend out of the mask through the perforation.

32. The horse-used protective mask as claimed in claim 12, wherein at least one perforation is formed on a top portion of the mask, whereby the ears of the horse can extend out of the mask through the perforation.

33. The horse-used protective mask as claimed in claim 13, wherein at least one perforation is formed on a top portion of the mask, whereby the ears of the horse can extend out of the mask through the perforation.

34. The horse-used protective mask as claimed in claim 17, wherein at least one perforation is formed on a top portion of the mask, whereby the ears of the horse can extend out of the mask through the perforation.

35. The horse-used protective mask as claimed in claim 18, wherein at least one perforation is formed on a top portion of the mask, whereby the ears of the horse can extend out of the mask through the perforation.

36. The horse-used protective mask as claimed in claim 19, wherein at least one perforation is formed on a top portion of the mask, whereby the ears of the horse can extend out of the mask through the perforation.
